(19) United States
(12) Patent Application Publication
(10) Pub. No.: US 2008/0095356 A1
(43) Pub. Date: Apr. 24, 2008

(54) Subscriber line interface circuit with discrete component linefeed driver

(76) Inventors: Ion C. Tesu, Austin, TX (US); Marius Goldenberg, Austin, TX (US)

Correspondence Address: DAVIS & ASSOCIATES, P.O. BOX 1093, DRIPPING SPRINGS, TX, 78620, US

(21) Appl. No.: 11/586,424

(22) Filed: Oct. 23, 2006

(51) Int. Cl. H04M 1/00

(52) U.S. Cl. 379/399.01

(57) ABSTRACT

A subscriber line interface circuit apparatus includes a signal processor having sense inputs for a sensed tip signal and a sensed ring signal of a subscriber loop. The signal processor generates at least one linefeed driver control current in response to the sensed signals. The signal processor is not a predominant source of any of a tip current or a ring current of the subscriber loop.

### FIELD OF THE INVENTION

This invention relates to the field of telecommunications. In particular, this invention is drawn to subscriber line interface circuitry.

### BACKGROUND

Subscriber line interface circuits are typically found in the central office exchange of a telecommunications network. A subscriber line interface circuit (SLIC) provides a communications interface between the digital switching network of a central office and an analog subscriber line. The analog subscriber line connects to a subscriber station or telephone instrument at a location remote from the central office exchange.

The analog subscriber line and subscriber equipment form a subscriber loop. The interface requirements of an SLIC typically result in the need to provide relatively high voltages and currents for control signaling with respect to the subscriber equipment on the subscriber loop. Voiceband communications are typically low voltage analog signals on the subscriber loop. Thus the SLIC must detect and transform low voltage analog signals into digital data for transmitting communications received from the subscriber equipment to the digital network. For bi-directional communication, the SLIC must also transform digital data received from the digital network into low voltage analog signals for transmission on the subscriber loop to the subscriber equipment.

One SLIC design includes discrete passive inductive components such as transformers for handling the higher voltages and currents. Disadvantages of this design include the bulkiness, weight, and power consumption of the passive inductive components.

Another SLIC design incorporates multiple specialized integrated circuits to achieve a transformerless SLIC. Typically one integrated circuit is dedicated to handling the low voltage digital signaling and another integrated circuit is dedicated to handling the higher-powered analog control signaling functions required for the subscriber loop. One disadvantage of this design is that programming of various SLIC operational characteristics is typically accomplished using discrete components such that the SLIC operational characteristics are not dynamically modifiable.

### SUMMARY OF THE INVENTION

A subscriber line interface circuit apparatus includes a signal processor having sense inputs for a sensed tip signal and a sensed ring signal of a subscriber loop. The signal processor generates at least one linefeed driver control current in response to the sensed signals. The signal processor is not a predominant source of any of a tip current or a ring current of the subscriber loop.

In one embodiment, the apparatus includes a linefeed driver for driving the subscriber loop in accordance with the at least one subscriber loop control current. The linefeed driver also provides the sensed tip and ring signals.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a subscriber line interface circuit including a signal processor and a linefeed driver.

FIG. 2 illustrates one embodiment of a SLIC linefeed driver.

FIG. 3 illustrates one embodiment of an improvement for the SLIC of FIG. 2.

FIG. 4 illustrates one embodiment of an improved SLIC linefeed driver.

### DETAILED DESCRIPTION

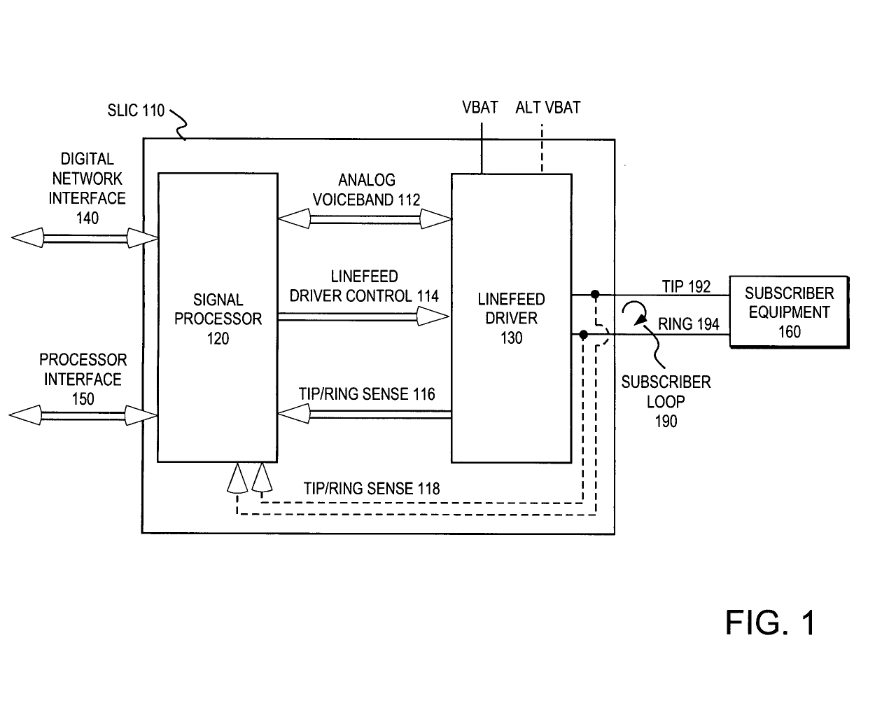

FIG. 1 illustrates one embodiment of a subscriber line interface circuit 110 associated with plain old telephone services (POTS) telephone lines. The subscriber line interface circuit (SLIC) provides an interface between a digital switching network of a local telephone company central exchange and a subscriber line comprising a tip 192 and a ring 194 line. A subscriber loop 190 is formed when the subscriber line is coupled to subscriber equipment 160 such as a telephone.

The subscriber loop 190 communicates analog data signals (e.g., voiceband communications) as well as subscriber loop “handshaking” or control signals. The subscriber loop state is often specified in terms of the tip 192 and ring 194 portions of the subscriber loop.

The SLIC is typically expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function, for example, enables the SLIC to signal the subscriber equipment 160. In one embodiment, subscriber equipment 160 is a telephone. Thus, the ringing function enables the SLIC to ring the telephone.

In the illustrated embodiment, the BORSCHT functions are distributed between a signal processor 120 and a linefeed driver 130. The signal processor and linefeed driver typically reside on a linecard (110) to facilitate installation, maintenance, and repair at a central exchange. Signal processor 120 is responsible for at least the ringing control, supervision, codec, and hybrid functions. Signal processor 120 controls and interprets the large signal subscriber loop control signals as well as handling the small signal analog voiceband data and the digital voiceband data.

In one embodiment, signal processor 120 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 120 receives subscriber loop state information from linefeed driver 130 as indicated by tip/ring sense 116. The signal processor may alternatively directly sense the tip and ring as indicated by tip/ring sense 118. This information is used to generate linefeed driver control 114 signals for linefeed driver 130. Analog voiceband 112 data is bi-directionally communicated between linefeed driver 130 and signal processor 120. In an alternative embodiment, analog voiceband signals are communicated downstream to the subscriber equipment via the linefeed driver but upstream analog voiceband signals are extracted from the tip/ring sense 118.

SLIC 110 includes a digital network interface 140 for communicating digitized voiceband data to the digital switching network of the public switched telephone network (PSTN). The SLIC may also include a processor interface 150 to enable programmatic control of the signal processor 120. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 130 maintains responsibility for battery feed to tip 192 and ring 194. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (−48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vᵣₘₛ).

Linefeed driver 130 modifies the large signal tip and ring operating conditions in response to linefeed driver control 114 provided by signal processor 120. This arrangement enables the signal processor to perform processing as needed to handle the majority of the BORSCHT functions. For example, the supervisory functions of ring trip, ground key, and off-hook detection can be determined by signal processor 120 based on operating parameters provided by tip/ring sense 116.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

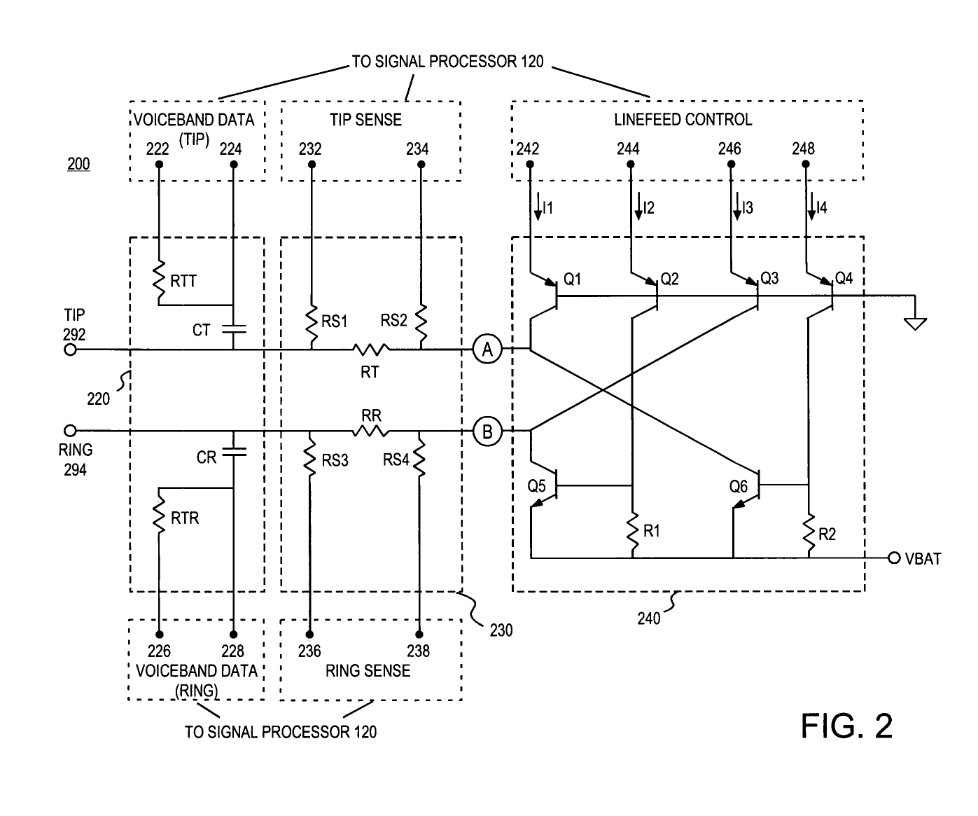

FIG. 2 illustrates an embodiment of a SLIC linefeed driver 200. In one embodiment, the linefeed driver 200 is implemented as a number of discrete components. Linefeed driver 200 includes voiceband circuitry 220, sensing circuitry 230, and power circuitry 240.

Voiceband circuitry 220 enables data signals corresponding to voiceband communications to be retrieved from (upstream) or impressed onto (downstream) the subscriber loop. Capacitors CR and CT effectively provide a.c. coupling for the upstream analog voiceband data from the subscriber loop to the signal processor while decoupling signal processor 120 from the d.c. offsets of the tip 292 and ring 294 nodes. Thus capacitors CR and CT effective provide d.c. isolation of the analog voiceband data interface formed by nodes 222-228 from the subscriber loop. In the embodiment illustrated, voiceband circuitry 220 provides a.c. coupling of the analog voiceband data between the subscriber loop and the signal processor using only passive components.

Voiceband communication is bi-directional between the subscriber loop and signal processor 120. Nodes 224 and 228 serve to communicate upstream voiceband data from the subscriber loop to signal processor 120 (i.e., tip and ring “audio in”). Nodes 222 and 226 provide a means of impressing a downstream signal on the subscriber loop from signal processor 120 (i.e., tip and ring “audio out”). In one embodiment RTT and RTR collectively establish a 600Ω termination impedance.

Sensing circuitry 230 enables signal processor 120 to determine the tip 292 and ring 294 node voltages as well as the subscriber loop current using sensing resistors RS1, RS2, RS3, and RS4. Resistors RT and RR are used to generate a voltage drop for determining the tip and ring currents. In one embodiment, sensing circuitry 230 consists only of passive discrete components.

Referring to FIG. 1, tip/ring sense 116, 118 includes a sensed tip signal and a sensed ring signal. In one embodiment, the sensed tip signal includes first and second sensed tip voltages. Resistors RS1 and RS2 are used to sense the tip line voltage at each end of RT. Resistors RS1 and RS2 convert the sensed tip line voltages to currents suitable for handling by signal processor 120 at nodes 232 and 234. The difference between the first and second sensed tip voltages is proportional to the tip current. Likewise, the sensed ring signal includes first and second sensed ring voltages. Resistors RS3 and RS4 similarly convert sensed ring line voltages at both ends of RR to currents suitable for handling by signal processor 120 at nodes 236 and 238. The difference between the first and second sensed ring voltages is proportional to the ring current. These calculations, however, can be performed as necessary by the signal processor 120 rather than the linefeed driver 130 circuitry. In addition, these sensed parameters enable the signal processor 120 to determine tip and ring voltages, tip and ring currents, the subscriber loop voltage, and the subscriber loop common mode and differential mode currents.

Power circuitry 240 provides the battery feed and other relatively high voltage functions to the subscriber loop in accordance with analog linefeed control signals provided by the signal processor 120 at nodes 242, 244, 246, and 248. Processing of the sensed parameters of the tip and ring lines for generating the linefeed control signals is handled exclusively by signal processor 120.

The subscriber loop current and the tip and ring voltages are controlled by transistors Q1-Q6. In one embodiment, Q1-Q4 are PNP bipolar junction transistors and Q5-Q6 are NPN bipolar junction transistors. Given that the base terminals of Q1-Q4 are coupled to ground, nodes 242-248 need only be approximately 0.7 volts to turn on transistors Q1-Q4. Due to the small voltage drop between the base and emitters of Q1-Q4, control of the linefeed circuitry requires relatively low power and thus linefeed driver control currents I1-I4 may be provided by a signal processor 120 implemented as a low voltage complementary metal oxide semiconductor (CMOS) integrated circuit.

Transistors Q1, Q4, and Q6 (and resistor R2) control the tip voltage 292. The tip voltage is increased by the application of control current I1 to Q1. The tip voltage (node 292) is decreased by the application of control current I4 to Q4. Thus control currents I1 and I4 effectively provide a pull up-pull down tip control signal for manipulating the tip voltage at node 292.

Similarly, transistors Q2, Q3, and Q5 (and resistor R1) control the ring voltage 294. The application of control current I3 to Q3 increases the ring voltage. The ring voltage is decreased by the application of control current I2 to Q2. Control currents I2 and I3 effectively provide a pull up-pull down ring control signal for manipulating the ring voltage at node 294.

Control currents I1-I4 thus effectively control the large signal subscriber loop current and tip and ring voltages. For example, the ringing signal can be generated by using the control signals at nodes 242-248 to periodically reverse the polarity of tip 292 with respect to ring 294 at the nominal ringing frequency.

Sensing portion 230 enables signal processor 120 to determine the large signal state of the subscriber loop without the need for intervening active circuitry or level shifters. In one embodiment, sensing portion 230 comprises only passive discrete components. The linefeed control inputs 242-248 enable signal processor 120 to actively manage the large signal state of the subscriber loop. In particular, the large signal a.c. and d.c. components of the subscriber loop control protocol can now be controlled directly by a low voltage integrated circuit. The large signal a.c. and d.c. control loops are effectively terminated at the signal processor 120, a low voltage integrated circuit.

Thus signal processing and state determination such as off-hook, ring trip, and ring control formerly associated with high power analog circuitry can be handled predominately by a low voltage integrated circuit. In addition, the integrated circuit signal processor can handle processing of the small signal analog voiceband data from the subscriber loop without the need for intervening active elements or level shifting circuitry.

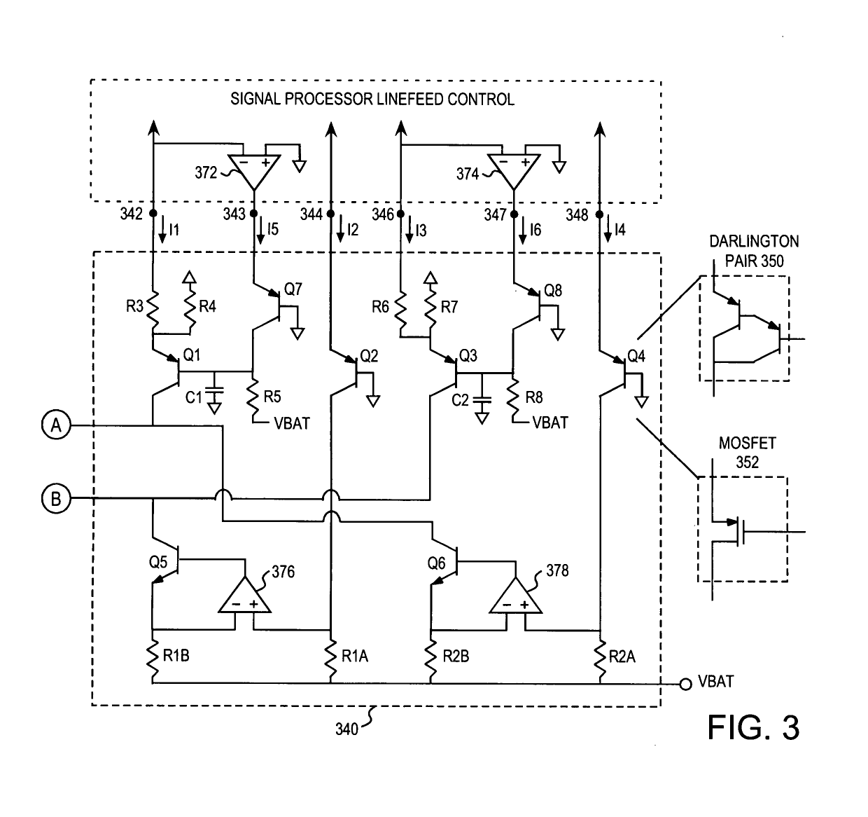

FIG. 3 illustrates one embodiment of an improved power circuitry 340 in lieu of the circuitry 240 of FIG. 2. The embodiment of FIG. 2 has been modified with the addition of discrete component capacitors (C1, C2), transistors (Q7, Q8), and resistors R3, R4, R5, R6, R7, R8, R2B, and R1B (R1A and R2A are renumbered from FIG. 2). In addition, transconductance amplifiers 372, 374, and operational amplifiers 376, 378 have been introduced. Capacitors C1 and C2 are provided for stability purposes.

In one embodiment, amplifiers 372 and 374 reside within signal processor 120 and connect to the remainder of the circuitry at nodes 343 and 347 of the signal processor. Nodes 342, 344, 346, and 348 are the counterparts of nodes 242, 244, 246, and 248 of FIG. 2. The addition of these components increases the number of pins, nodes, pads, or contact points (343, 347) of any integrated circuit signal processor interfacing with power circuitry 340. Due to the magnitude of VBAT, amplifiers 376 and 378 are discrete components. The use of audio quality current amplifiers enables class AB operation for voiceband signaling as well as for ringing and on-hook transmission.

Referring to FIG. 2, the signal processor is required to provide control currents I1, I4 and I3, I2 that are the predominant contributors to the tip and ring currents. Thus the source of the tip and ring currents of FIG. 2 is predominately the signal processor. Voltage mirroring and a few additional discrete components are used to create current amplifiers to permit offloading this current demand from the signal processor. In particular, through appropriate choice of resistor values, the control currents I1-I4 provided by the signal processor of FIG. 3 can be a mere fraction of the currents provided by the signal processor of FIG. 2.

For illustration consider the tip control currents, I1 and I4 with the following resistor value assignments:

R3=mR4

R2A=nR2B

With reference to the tip pull-up control, control current I1 establishes a voltage across resistor R3. Due to transconductance amplifier 372, however, node 342 is at a virtual ground. Thus the voltage across resistor R4 is the same as that across R3 (i.e., V_{R3}=V_{R4}). The current through R4 is m times the current through R3.

V_{R3}=I_{R3}R³; V_{R4}=I_{R4}R4

I_{R4}R4=I_{R3}R3=I_{R3}mR4

I_{R4}=mI_{R3}

The total current provided to the emitter of Q1 is I_{R3}+I_{R4} which may also be expressed as (m+1)I_{R3}. Given that I_{R3}=I1, appropriate choice of m will result in emitter current drawn predominately through ground rather than through the signal processor. Choosing m=49 for the circuitry of FIG. 3, for example, will result in a Q1 emitter current of I_{Q1}=50·I1. The control current I1 for the circuitry of FIG. 3 is

$$\frac{1}{m + 1} = 1 / {50}^{th}$$

the control current that would otherwise required from the signal processor for the circuitry of FIG. 2.

With reference to the tip pull-down control, control current I4 establishes a voltage across R2A. Operational amplifier 378 drives transistor Q6 to ensure that V_{R2B}=V_{R2A}. Assuming that the beta of transistor Q4 is high enough such that the base current of Q4 is negligible (i.e., I_{CQ4}≈I_{EQ4}=I4):

V_{R2B}=I_{Q6}·R2B=V_{R2A}=I4·R2A

From which:

$$\frac{{I}_{Q 6}}{I 4} = \frac{R 2 A}{R 2 B} = n$$

Thus the emitter current of Q6 is a multiple n of the control current I4. This emitter current is provided by a source other than the signal processor. In order to provide a symmetrical pull-pull operation for the tip line, changes in I1 and I4 should have complementary effects for the same amount of change thus n and m should be selected such that n=m+1.

The examples presented above with respect to Q1, Q4, Q6 and the control of the tip line similarly apply to Q2, Q3, Q5 and the control of the ring line. For purposes of analysis assume:

R6=hR7

R1A=kR1B

The total current provided to the emitter of Q3 is I_{R6}+I_{R7}. Due to the virtual ground provided at node 346 by transconductance amplifier 374, the voltage across R6 (V_{R6}) is the same as the voltage across R7 (V_{R7}). If R6=hR7, then I_{R7}=hI_{R6} The appropriate choice of h will result in Q3 emitter current drawn predominately through ground rather than through the signal processor. For h=49, the Q3 emitter current is 50·I3. The control current I3 for the circuitry of FIG. 3 is thus

$$\frac{1}{h + 1} = 1 / {50}^{th}$$

of the control current that would otherwise be required from the signal processor for the circuitry of FIG. 2.

Control current I2 establishes a voltage across R1A. Operational amplifier 376 drives transistor Q5 to ensure that V_{R1B}=V_{R1A}. Assuming that the beta of transistor Q2 is high enough such that the base current of Q2 is negligible (i.e., I_{CQ2}≈I_{EQ2}=I2), then:

V_{R1B}=I_{Q5}·R1B=V_{R1A}=I2·R1A

From which:

$$\frac{{I}_{Q 5}}{I 2} = \frac{R 1 A}{R 1 B} = k$$

Thus the emitter current of Q6 is a multiple k of the control current I2. This emitter current is provided by a source other than the signal processor. In order to provide a symmetrical pull up-pull down operation for the tip line, changes in I2 and I3 should have complementary effects for the same amount of change thus h and k should be selected such that k=h+1.

Choosing n=m+1 and k=h+1 enables balance in the pull-up and pull-down of the individual tip and ring lines. For ease of control, an additional constraint of n=k may be imposed such that n=m+1=h+1=k.

Referring to FIG. 2, the predominant source of current feeding the tip and ring lines is provided by the signal processor. In particular, the control currents I1-I4 and therefore the signal processor is the predominant source of the tip or ring currents. Referring to FIG. 3, however, the contribution of the control currents I1-I4 to the tip or ring currents is 1/n. For even relatively small n, (e.g., n=3), the signal processor is not the predominant source of the tip or ring currents. For the illustrated embodiment, n=50. In various embodiments, n≧10.

Audio (i.e., voiceband) signals may be communicated to the subscriber equipment through modulation of the control currents. With respect to FIG. 2, audio signals may have been superimposed upon control currents I1 and I3. This required a pedestal current through I3 for class A operation. Class A operation, however, requires more current than class AB operation. Referring to FIG. 3, the added components permit class AB operation for communicating audio signals to the subscriber equipment.

Referring to FIG. 3, control currents I1 and I4 are modulated to communicate voiceband signals to the subscriber equipment when the SLIC is operated in a forward mode. Control currents I2 and I3 are modulated to communicate voiceband signals to the subscriber equipment when the SLIC is operated in a reverse mode. The tip line is more positive than the ring line when the SLIC is in the forward mode. The ring line is more positive than the tip line when the SLIC is in the reverse mode. The use of control currents I1 and I4 or I2 and I3 for voiceband communications enables class AB operation for voiceband communications.

Referring to FIGS. 2-3, the use of modulated control currents to impress downstream voiceband communications onto the subscriber line permits the elimination of RTT, RTR and nodes 222, 226. The elimination of nodes 222, 226 implies fewer pins/nodes/contacts for the integrated circuit signal processor.

Although modeled as bipolar junction transistors (BJT), transistors Q1-Q6 may be implemented as Darlington transistor pairs of the appropriate p/n type. For example, a Darlington transistor pair 350 is illustrated as an alternative for Q4. Alternatively, transistors Q1-Q6 may be implemented as metal-oxide semiconductor field effect transistors (MOSFET) of the appropriate p/n type. For example, MOSFET 352 is illustrated as an alternative for Q4.

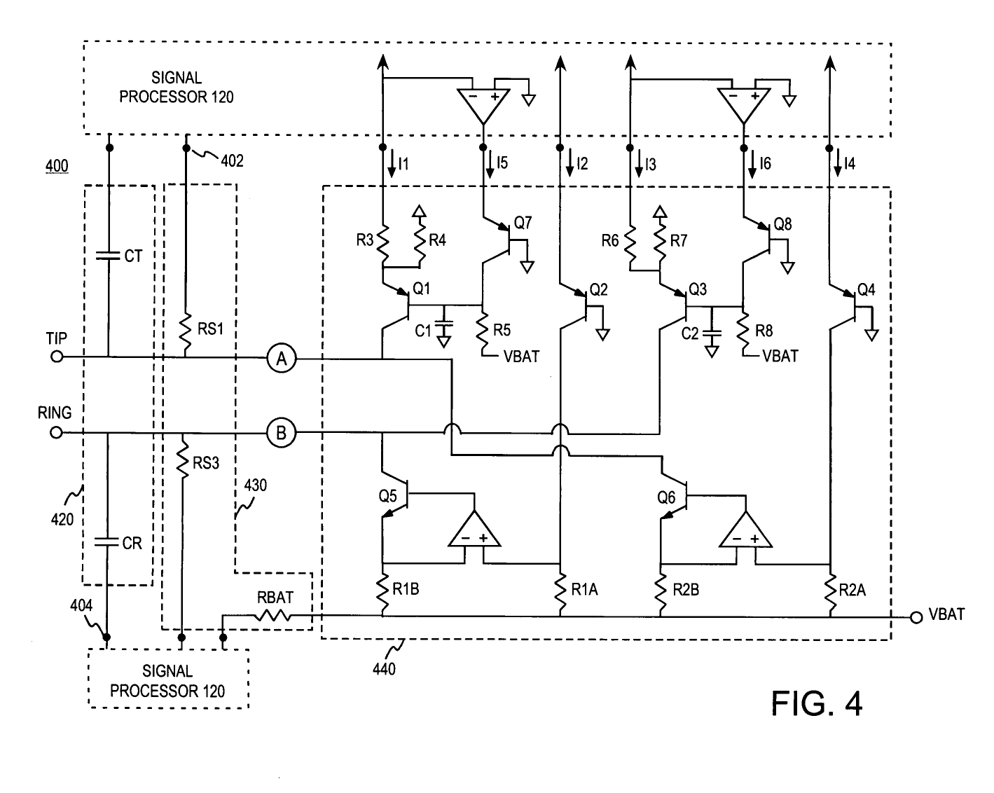

FIG. 4 illustrates an embodiment of the linefeed driver circuitry 400 including voiceband circuitry 420, sensing circuitry 430, and power circuitry 440. The voiceband circuitry is configured only for receiving voiceband communications from the subscriber line. Voiceband signals are communicated from the SLIC downstream to the subscriber equipment by superimposing the audio signals on control currents I1 and I4 or I2 and I3 depending upon operational mode of the SLIC.

The sensing circuitry 420 is simplified from the sensing circuitry of FIG. 2 by the use of RS1, RS3, and RBAT. RS1 and RS2 are used to enable the signal processor 120 to determine the tip and ring voltages, respectively. RBAT is used to enable the signal processor to determine VBAT. Knowledge of VBAT enables the signal processor 120 to determine headroom for ringing and other functions.

The linefeed driver circuitry is coupled to the signal processor pins, nodes, or contacts 402, 404. In one embodiment, nodes 402, 404 correspond to pins of an integrated circuit package.

A subscriber line interface circuit including a signal processor and linefeed driver has been described. The signal processor senses each of the tip and ring signals and generates at least one linefeed driver control current in response to the sensed signals. The control current is a fraction (1/n, n≧3) of the tip or ring currents such that the signal processor is not the predominant source of the tip and ring currents for the subscriber line. In various embodiments, the signal processor is fabricated as an integrated circuit. In one embodiment, the signal processor is fabricated as a complementary metal oxide semiconductor (CMOS) integrated circuit.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A subscriber line interface circuit apparatus comprising:
a signal processor having sense inputs for a sensed tip signal and a sensed ring signal of a subscriber loop, wherein the signal processor generates at least one linefeed driver control current in response to the sensed signals, wherein the signal processor is not a predominant source of any of a tip current or a ring current of the subscriber loop.

2. The apparatus of claim 1 wherein the sensed tip signal is a differential signal proportional to a tip current, wherein the sensed ring signal is a differential signal proportional to a ring current.

3. The apparatus of claim 1 wherein the signal processor is fabricated as a complementary metal oxide semiconductor (CMOS) integrated circuit.

4. The apparatus of claim 1 wherein the at least one control current includes any of a ring pull-up control current, a ring pull-down control current, a tip pull-up control current, and a tip pull-down current, wherein the pull-up currents increase a line voltage of an associated tip and ring line, wherein pull-down currents decrease a line voltage of the associated tip and ring line.

5. The apparatus of claim 1 wherein an amount of tip or ring current contributed by the signal processor is 1/n of the tip or ring current.

6. The apparatus of claim 5 wherein n≧3.

7. The apparatus of claim 5 wherein n≧10.

8. An apparatus comprising:
a signal processor having sense inputs for a sensed tip signal and a sensed ring signal of a subscriber loop, wherein the signal processor generates at least one linefeed driver control current in response to the sensed signals; and
a linefeed driver for driving the subscriber loop in accordance with the at least one subscriber loop control current, the linefeed driver providing the sensed tip and ring signals, wherein the signal processor is not a predominant source of any of a tip current or a ring current of the subscriber loop.

9. The apparatus of claim 8 wherein the sensed tip signal is a differential signal proportional to a tip current, wherein the sensed ring signal is a differential signal proportional to a ring current.

10. The apparatus of claim 8 wherein the signal processor is fabricated as a complementary metal oxide semiconductor (CMOS) integrated circuit.

11. The apparatus of claim 8 wherein the at least one control current includes any of a ring pull-up control current, a ring pull-down control current, a tip pull-up control current, and a tip pull-down current, wherein the pull-up currents increase a line voltage of an associated tip and ring line, wherein pull-down currents decrease a line voltage of the associated tip and ring line of the subscriber loop.

12. The subscriber loop linefeed driver of claim 8 further comprising:
voiceband circuitry for bi-directional communication of voiceband data between the subscriber loop and a voiceband data interface of the integrated circuit, wherein the voiceband circuitry provides the analog voiceband data interface with d.c. isolation from each of the ring and tip lines of the subscriber loop.

13. The apparatus of claim 8 wherein the signal processor operates in a positive voltage range with respect to ground, wherein the linefeed driver operates at a negative d.c. voltage offset relative to the signal processor.

14. The apparatus of claim 8 wherein the signal processor performs at least one of the subscriber loop supervisory functions of ring trip, ground key, and off-hook detection.

15. The apparatus of claim 8 wherein the signal processor further comprises a programming interface to enable programmatic control of at least one of the following parameters: battery control, battery feed state control, voiceband data amplification, voiceband data level shifting, longitudinal balance, ringing current, ring trip detection threshold, off-hook detection threshold, and audio output signal termination impedance for voiceband communication signals superimposed on the linefeed driver control currents.

16. The apparatus of claim 8 wherein the signal processor superimposes voiceband communications on the at least one linefeed driver control current.

17. The apparatus of claim 8 wherein the signal processor superimposes voiceband communications on a tip pull-up control current and a tip pull-down control current when the SLIC is operating in a forward mode, wherein the signal processor superimposes voiceband communications on a ring pull-up control current and a ring pull-down control current when the SLIC is operating in a reverse mode.

18. The apparatus of claim 8 wherein amount of a tip or a ring current contributed by the signal processor is 1/n of the tip or ring current.

19. The apparatus of claim 19 wherein n≧3.

20. The apparatus of claim 19 wherein n≧10.
